(19) United States
(12) Patent Application Publication
(10) Pub. No.: US 2026/0370953 A1
(43) Pub. Date: Nov. 19, 2026

(54) IMAGE CAPTURING APPARATUS, CONTROL METHOD THEREOF, AND STORAGE MEDIUM

(71) Applicant: CANON KABUSHIKI KAISHA, Tokyo (JP)

(72) Inventor: KAZUYA KITAMURA, Kanagawa (JP)

(21) Appl. No.: 19/659,227

(22) Filed: Apr. 27, 2026

(30) Foreign Application Priority Data
May 13, 2025 (JP) 2025-080611

(51) Int. Cl. H04N 23/72; H04N 23/60; H04N 23/73; H04N 23/74; H04N 23/741

(52) U.S. Cl. CPC H04N 23/72; H04N 23/73; H04N 23/74; H04N 23/741; H04N 23/64

(57) ABSTRACT

An image capturing apparatus includes an image sensor, an image capturing control unit that controls image capturing, a composite processing unit that performs composite processing for compositing a first image signal obtained and a second image signal, the first image signal and the second image signal being obtained by the image capturing control unit causing each pixel of the image sensor to perform the first image capturing with a first exposure time and the second image capturing with a second exposure time, and a determination unit that, based on the first image signal and the second image signal, determines presence/absence of a light source that intermittently emits light, and determine whether a phase relationship between timings of the first image capturing and the second image capturing and a timing of light emission of the light source.

### BACKGROUND

### Field of the Technology

The present disclosure relates to a technology for synchronizing a light emission timing of a light source with an image capturing timing of an image capturing apparatus.

### Description of the Related Art

Some of what are called CMOS sensors are called a GS sensor that enables a global shutter (hereinafter referred to as GS) operation by having a memory unit in each pixel. The pixel of this GS sensor includes a gate that transfers signal electric charges accumulated in a photoelectric conversion portion to a charge accumulation portion. In the GS sensor, basically, charges are transferred from the photoelectric conversion portion to the charge accumulation portion simultaneously for all the pixels. Therefore, the timings of signal accumulation start and end in the photoelectric conversion portion become the same for all the pixels, and the GS function is realized.

There is also a known GS sensor that can generate an image with a wide dynamic range (high dynamic range image) by providing one photoelectric conversion portion with a plurality of charge accumulation portions. Specifically, one photoelectric conversion portion is provided with a plurality of charge accumulation portions, signal electric charges are transferred to each charge accumulation portion a plurality of times in one frame, and accumulation times of the signal electric charges transferred to each charge accumulation portion are made different. Then, an image generated based on the signal on the side where the accumulation time is short and an image generated based on the signal on the side where the accumulation time is long are acquired. By compositing these images, one image with a wide dynamic range can be generated. US 2013/0135486 discloses a configuration of such a GS sensor.

However, when a light source controlled to periodically repeat light emission for a very short time is included in a shooting object, there is a possibility that the light source emits light only in a period on the side where the accumulation time of the GS sensor is short or on the side where it is short depending on the light emission timing of the light source. In this case, there is a problem that the light source is shot with a luminance different from assumed luminance.

### SUMMARY

The present disclosure has been made in view of the above-described problems, and suppresses an image with a luminance different from assumed luminance from being shot even in a case in which a subject includes a light source that periodically repeats light emission for a short time.

According to an aspect of the present disclosure, there is provided an image capturing apparatus comprising: an image sensor including a plurality of pixels arrayed in a matrix; and at least one processor or circuit and a memory storing instructions to cause the at least one processor or circuit to perform operations of the following units an image capturing control unit that controls image capturing in the image sensor, a composite processing unit that performs composite processing for compositing a first image signal obtained in first image capturing and a second image signal obtained in second image capturing, the first image signal and the second image signal being obtained by the image capturing control unit causing each pixel of the image sensor to perform the first image capturing with a first exposure time and the second image capturing with a second exposure time different from the first exposure time, and a determination unit that, based on the first image signal and the second image signal, determines presence/absence of a light source that intermittently emits light, and determine whether a phase relationship between timings of the first image capturing and the second image capturing and a timing of light emission of the light source that intermittently emits light is a predetermined phase relationship.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram of an image sensor in a first embodiment.

FIG. 2 is a circuit diagram of a pixel in the first embodiment.

FIG. 3 is a timing chart of a pixel circuit in the first embodiment.

FIG. 4 is a timing chart of the pixel circuit in the first embodiment.

FIG. 5 is an explanatory view of dynamic range expansion composite processing in the first embodiment.

FIG. 6 is a block diagram illustrating a configuration of an image capturing apparatus in the first embodiment.

FIG. 7 is a view illustrating a shooting system in the first embodiment.

FIG. 8 is a block diagram of the dynamic range expansion composite processing in the first embodiment.

FIGS. 9A to 9C are views illustrating an exposure timing of an image sensor and a light emission timing of a light source in the first embodiment.

FIG. 10 is a flowchart showing warning notification processing in the first embodiment.

FIG. 11 is a view illustrating an example of region division of video data in the first embodiment.

FIG. 12 is a view illustrating an example of a video displayed on a display unit in the first embodiment.

FIG. 13 is a flowchart showing automatic phase adjustment processing in a second embodiment.

FIG. 14 is a flowchart showing dynamic range expansion composite processing of video data in a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

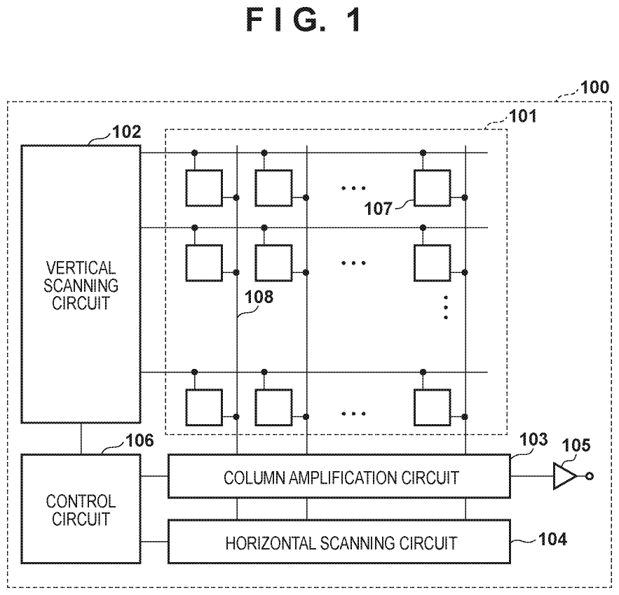

FIG. 1 is a block diagram illustrating a schematic configuration of an image sensor used in an image capturing apparatus of the first embodiment of the present disclosure.

An image sensor 100 includes a pixel portion 101, a vertical scanning circuit 102, a column amplification circuit 103, a horizontal scanning circuit 104, an output circuit 105, and a control circuit 106. In plan view of a substrate, the pixel portion 101 is a pixel array including a plurality of pixels 107 arrayed in a two-dimensional (matrix) manner including a plurality of rows and a plurality of columns. The vertical scanning circuit 102 supplies a control signal to a plurality of transistors included in the pixels 107, and controls on (conductive state) or off (non-conductive state) of these transistors.

Each column of the pixels 107 is provided with a signal line 108, and signals from the pixels 107 are read out to the signal line 108 for each column. The column amplification circuit 103 amplifies the pixel signals output to the signal line 108, and performs processing such as correlated double sampling processing based on signals at the time of resetting the pixels 107 and signals at the time of photoelectric conversion. The horizontal scanning circuit 104 supplies a control signal to a switch connected to an amplifier of the column amplification circuit 103, and controls the switch to turn it on or off.

The control circuit 106 controls the vertical scanning circuit 102, the column amplification circuit 103, and the horizontal scanning circuit 104. The output circuit 105 includes a buffer amplifier and a differential amplifier, and outputs, to a signal processing unit outside the image sensor, the pixel signals from the column amplification circuit 103. Note that by further providing the image sensor 100 with an AD conversion unit, the image sensor 100 may be configured to output digital pixel signals.

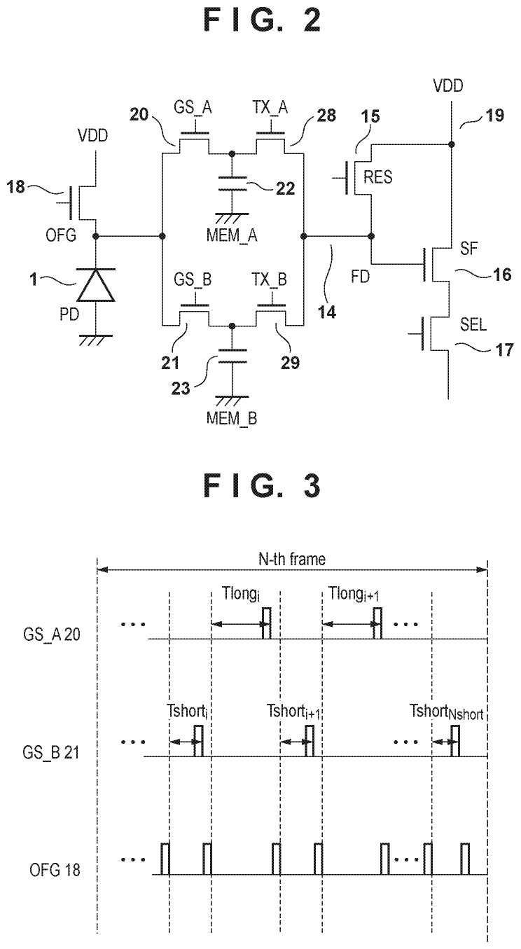

FIG. 2 is an equivalent circuit diagram of a unit pixel of the image sensor.

PD1 indicates a photodiode as an example of the photoelectric conversion portion. GS_A 20 and GS_B 21 denote electric charge transfer portions. These are configured to be able to transfer the signal electric charge generated by the photoelectric conversion portion PD1 to the circuit element of the subsequent stage. MEM_A 22 and MEM_B 23 denote charge accumulation portions (charge holding portions). These are configured to be able to hold the signal electric charges generated by the photoelectric conversion portion PD1. When turned on, the electric charge transfer portion GS_A 20 transfers the signal electric charge generated by the photoelectric conversion portion PD1 to the charge accumulation portion MEM_A 22. When turned on, the electric charge transfer portion GS_B 21 transfers the signal electric charge generated by the photoelectric conversion portion PD1 to the charge accumulation portion MEM_B 23. These transfers are performed simultaneously for all the pixels.

TX_A 28 and TX_B 29 denote transfer portions. Each of them is configured to be able to transfer the signal electric charge held in the charge accumulation portion of the preceding stage to the circuit element of the subsequent stage.

When turned on, the electric charge transfer portion TX_A 28 transfers the signal electric charge held in the charge accumulation portion MEM_A 22 to a floating diffusion portion (FD) 14. When turned on, the electric charge transfer portion TX_B 29 transfers the signal electric charge held in the charge accumulation portion MEM_B 23 to the FD 14.

SEL 17 denotes a selection portion. It is configured such that each pixel can be selected and read out to the outside for each pixel or each pixel row. An OFG 18 is a charge discharging control unit that can discharge the charge in the photoelectric conversion portion PD1. For example, a MOS transistor can be used as the charge discharging control unit. In this case, the charge discharging control unit is configured such that a semiconductor region having the same polarity as the signal electric charge constituting a part of the photoelectric conversion portion serves as a source, and a semiconductor region (overflow drain region: OFD region) to which a power supply voltage VDD 19 is supplied serves as a drain. A MOS transistor can be used for each transfer portion, a reset portion the selection portion, and the charge discharging control unit.

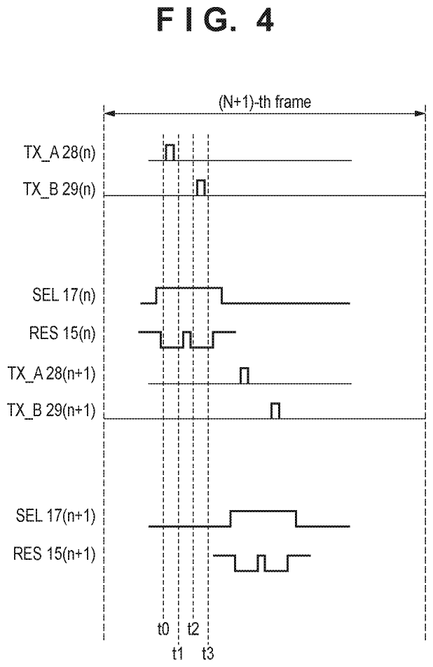

Next, a driving method (shooting control) in the present embodiment will be described with reference to FIGS. 3 and 4. FIG. 3 illustrates timing for drive related to exposure, and FIG. 4 illustrates timing for drive related to readout. The subscript n denotes the row number of the pixel. The subscripts of the respective control lines indicate the n-th row and the (n+1)-th row. Two rows will be described here, but also a case of further including a plurality of rows can be handled by repeating this drive pattern. Since the image sensor is a global shutter type, the drive timing is the same for all rows regarding the drive related to exposure. Therefore, subscripts and notations for a plurality of lines are not performed. An example of active-high is illustrated.

Tshorti in FIG. 3 indicates the accumulation time of the signal electric charge of the i-th time of the charge transfer repeated a plurality of times, for example, Nshort times in the N-th frame. This accumulation time corresponds to a time from when the charge discharging control unit OFG 18 is turned on and the photoelectric conversion portion PD1 is reset to when the transfer portion GS_B 21 is turned on, the generated signal electric charge is transferred from the photoelectric conversion portion PD1 to the charge accumulation portion MEM_B 23, and the transfer portion GS_B 21 is turned off. The accumulation time Tshort of the signal electric charge accumulated in the charge accumulation portion MEM_B 23 can be said to be a time in which Tshorti is added from i=1 to i=Nshort.

Tlongi in FIG. 3 indicates the accumulation time of the signal electric charge of the i-th time of the charge transfer repeated a plurality of times, for example, Nlong times in the N-th frame. This accumulation time corresponds to a time from when the charge discharging control unit OFG 18 is turned on and the photoelectric conversion portion PD1 is reset to when the transfer portion GS_A 20 is turned on, the generated signal electric charge is transferred from the photoelectric conversion portion PD1 to the charge accumulation portion MEM_A 22 and the transfer portion GS_A 20 is turned off. The accumulation time Tlong of the signal electric charge accumulated in the charge accumulation portion MEM_A 22 can be said to be a time in which Tlongi is added from i=1 to i=Nlong.

Signal readout of the (N+1)-th frame will be described with reference to FIG. 4. Here, readout of signal electric charges acquired in the previous frame (N-th frame) and held in MEM_A22 and MEM_B23 is performed. The signal readout in the n-th row will be described in the form of sequentially reading out in rows.

SEL 17(n) is turned on so that the signal of the FD 14 of the pixel of the n-th row can be read out. RES 15(n) that resets the FD 14 when turned on is turned off, and a reset level voltage VRES of the FD 14 is read out (time t0). Next, TX_A 28(n) is turned on, the signal electric charge retained in MEM_A 22 is transferred to the FD 14, and a signal level VSIG of the FD 14 is read out (time t1). The difference between these two signal levels, |VSIG−VRES|, is a physical quantity proportional to the signal electric charge amount of MEM_A 22. RES15(n) is turned on again, the FD 14 is reset, and the reset level voltage VRES of the FD 14 is read out (time t2). Next, TX_B 29(n) is turned on, the signal electric charge retained in MEM_B 23 is transferred to the FD 14, and the signal level VSIG of the FD 14 is read out (time t3). The difference between these two signal levels, |VSIG−VRES|, is a physical quantity proportional to the signal electric charge amount of MEM_B 23. This is repeated sequentially for each row in all or a region desired to be acquired, and signals of MEM_A22 and MEM_B23 are acquired as images.

As described above, one photoelectric conversion portion PD1 includes two charge accumulation portions that accumulate signal electric charges to be transferred, and the respective accumulation times are controlled, whereby two images having different exposure times can be acquired. Then, by generating a composite image signal by compositing these images, it is possible to acquire a high dynamic range image.

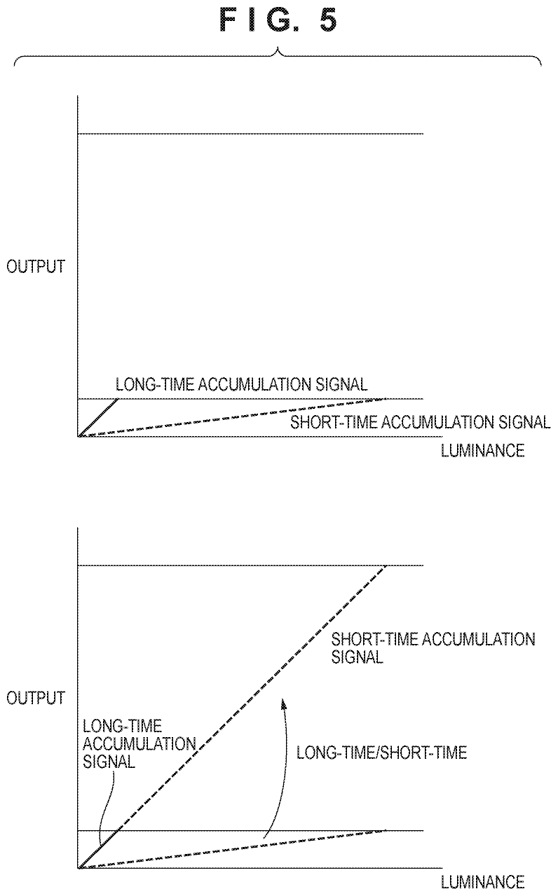

FIG. 5 is a view illustrating an outline of dynamic range expansion composite processing.

In the present embodiment, compositing is performed by combining both image signals, as an example, by using an image signal acquired from a charge accumulation portion with a long accumulation time for an image at a normal luminance level, and using an image signal acquired from a charge accumulation portion with a short accumulation time for a high luminance part with a bright, whiteout level. In the dynamic range expansion composite processing, α blending (weighted addition) or the like is used to smoothly connect a switching portion of the image so as not to be noticeable.

Here, before the dynamic range expansion composite processing is performed, it is necessary to adjust the luminance of the image with a short accumulation time to the luminance of the image with a long accumulation time. Since the respective accumulation times are known, it is theoretically possible to correctly perform the dynamic range expansion composite processing by multiplying the image data acquired from the charge accumulation portion with the short accumulation time by the ratio of the accumulation times.

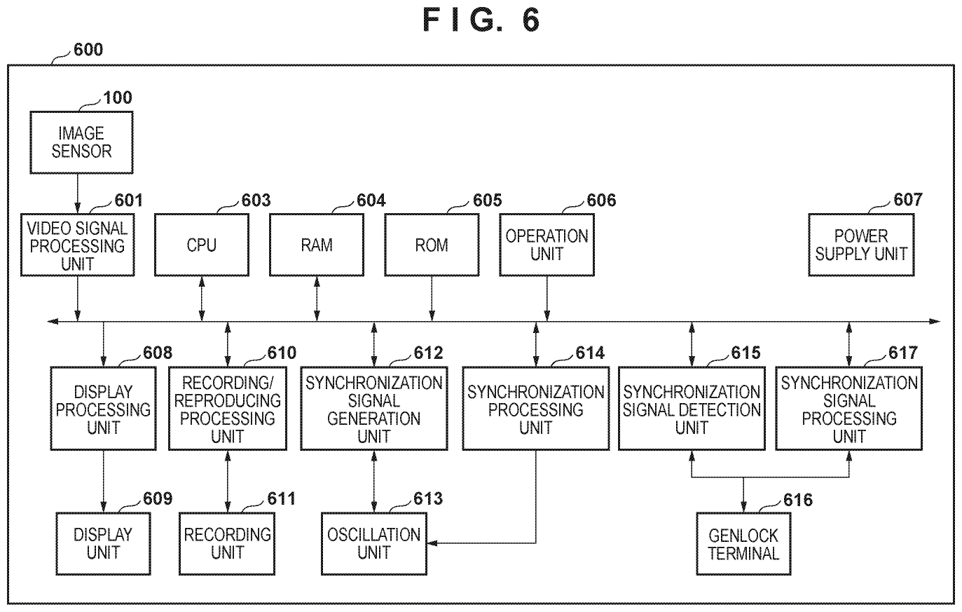

FIG. 6 is a block diagram illustrating an internal configuration of an image capturing apparatus 600. In FIG. 6, the image capturing apparatus 600 is configured to be able to perform input, output, and recording of an image.

The image sensor 100 converts an optical image of a subject formed by a shooting lens (not illustrated) into an electrical signal and outputs it to a video signal processing unit 601.

The video signal processing unit 601 performs A/D conversion processing and dynamic range expansion composite processing of a long-time accumulation signal and a short-time accumulation signal on the electrical signal obtained from the image sensor 100, and generates video data. The video signal processing unit 601 can also divide the video region into predetermined regions and calculate the mean value of the long-time accumulation signals and the mean value of the short-time accumulation signals for each divided region. The video data may be held in a RAM 604 as necessary, or may be sent to a display processing unit 608 or a recording/reproducing processing unit 610 without passing through the RAM 604.

A CPU 603 performs various types of control by executing a control program stored in a ROM 605. The RAM 604 is used for storage of data when the CPU 603 executes a program. It is also used for storage of video data. The ROM 605 is also used for holding display data and the like in addition to programs.

The CPU 603 issues an instruction to each unit based on the input operation received via an operation unit 606. For example, by sending an instruction to the recording/reproducing processing unit 610, recording can be started or stopped. In a case in which a menu display operation is performed, it is possible to send the display data read from the ROM 605 to the display processing unit 608 and display the menu.

The operation unit 606 is an operation means for a user to input an instruction to each function block of the image capturing apparatus 600.

A power supply unit 607 supplies power to each block of the image capturing apparatus 600 in response to a power-on instruction issued by the user operating the operation unit 606.

The display processing unit 608 composites video data generated by the video signal processing unit 601 or video data reproduced by the recording/reproducing processing unit 610 with display data such as a character string read from the ROM 605 by the CPU 603, and then outputs the composited data to a display unit 609 as a video signal.

The display unit 609 displays the video signal output from the display processing unit 608. For example, a display element such as a liquid crystal panel is used. The display unit 609 may be a separate body from the image capturing apparatus 600, such as an external monitor.

The recording/reproducing processing unit 610 has a function of encoding (compressing) and decoding (decompressing) a video signal, encodes video data generated by the video signal processing unit 601, and records the video data in a recording unit 611 as a moving image file. As an encoding method, Moving Picture Experts Group 2 (MPEG2), H.264, H.265, or the like is used. When reproduction of a moving image file is instructed from the CPU 603, a desired moving image file is read from the recording unit 611 and decoded to generate video data.

The recording unit 611 includes, for example, a random accessible recording medium such as a flash memory card. The recording unit 611 is detachable from the image capturing apparatus 600 by a mounting and discharging mechanism (not illustrated). The CPU 603 manages various types of data to be recorded in the recording unit 611 as files in accordance with a known file system such as a FAT file system.

Based on a clock supplied from an oscillation unit 613, a synchronization signal generation unit 612 generates and supplies, to each unit, a horizontal synchronization signal and a vertical synchronization signal of a video. Video signal processing and display processing are performed in synchronization with these horizontal synchronization signal and vertical synchronization signal (with reference to a synchronization signal).

Based on the clock supplied from the oscillation unit 613, the synchronization signal generation unit 612 generates a free-running horizontal synchronization signal and a free-running vertical synchronization signal (internal synchronization signals), and notifies a synchronization processing unit 614 of the switching timing of the free-running synchronization.

The oscillation unit 613 is constituted by a device that can control the frequency of a clock to be supplied, such as a voltage-controlled crystal oscillator (VCXO).

A synchronization signal detection unit 615 detects whether a synchronization signal (external synchronization signal) is input to a genlock terminal 616. The CPU 603 can know the input state of the synchronization signal by inquiring the synchronization signal detection unit 615. When the synchronization signal is detected, the CPU 603 instructs the synchronization processing unit 614 to start synchronization processing using the synchronization signal.

A synchronization signal processing unit 617 extracts a horizontal synchronization signal and a vertical synchronization signal from the synchronization signal, and sends signals indicating the timings to the synchronization processing unit 614.

Next, synchronization processing will be described.

The synchronization processing unit 614 counts, with a clock supplied from the oscillation unit 613, the length between the timings of the horizontal synchronization signals sent from the synchronization signal processing unit 617.

Upon receiving a synchronization processing start instruction from the CPU 603, the synchronization processing unit 614 compares the length between the timings of the free-running horizontal synchronization signals generated by the synchronization signal generation unit 612 with the length between the timings of the horizontal synchronization signals detected by the synchronization signal detection unit 615, performs feedback control on the oscillation unit 613 so as to eliminate the difference, and controls the frequency of the clock output from the oscillation unit 613.

When the difference in length between the timings of the free-running horizontal synchronization signal and the input horizontal synchronization signal falls within a predetermined range, the synchronization processing unit 614 notifies the CPU 603 of completion of clock synchronization.

Next, the CPU 603 inquires of the synchronization processing unit 614 about a phase difference between the timing of the free-running vertical synchronization signal generated by the synchronization signal generation unit 612 and the input vertical synchronization signal detected by the synchronization signal processing unit 617. Then, the CPU 603 notifies the synchronization signal generation unit 612 of the phase difference inquired of the synchronization processing unit 614.

By re-outputting the free-running synchronization signal and the synchronization signal of the video while shifting them by the phase difference notified from the CPU 603, the synchronization signal generation unit 612 can keep the phase difference between the free-running synchronization signal and the input synchronization signal within a predetermined range.

Next, phase adjustment processing in response to a user operation performed after completion of the synchronization processing will be described.

First, the user operates the operation unit 606, whereby a phase adjustment menu screen is displayed on the display unit 609, and the phase adjustment setting is received.

By operating the operation unit 606, the user can change and set the adjustment value displayed on the phase adjustment menu screen. The set adjustment value is stored in the RAM 604.

Next, the synchronization signal generation unit 612 re-generates and supplies, to each unit of the image capturing apparatus 600, the horizontal synchronization signal and the vertical synchronization signal whose phases are shifted in response to adjustment values stored in the RAM 604, and notifies the CPU 603 that the phase adjustment processing has been performed. Image capturing, video signal processing, display processing, and the like are performed in synchronization with these horizontal synchronization signal and vertical synchronization signal.

The above processing enables the image capturing processing and the like to be performed in a state in which a predetermined phase difference is given to the input synchronization signal, and the exposure timing of the image sensor 100 to be shifted accordingly.

FIG. 7 is a view illustrating a shooting system in the first embodiment, and the image capturing apparatus 600, a video signal processing apparatus 701, and a display apparatus 702 are connected in a wired or wireless manner.

The display apparatus 702 is an apparatus that controls a light source (not illustrated) to display a video signal input via a video input terminal (not illustrated).

The image capturing apparatus 600 captures a subject 703 and a video displayed on the display apparatus 702 in synchronization with the synchronization signal output from video signal processing apparatus 701.

A coordinate detection apparatus 704 is attached to the image capturing apparatus 600, detects a position and a posture of the image capturing apparatus 600 by referring to a marking applied to a ceiling or a floor or by irradiating infrared rays or the like and detecting reflected light from the marking, and transmits detected information to the video signal processing apparatus 701.

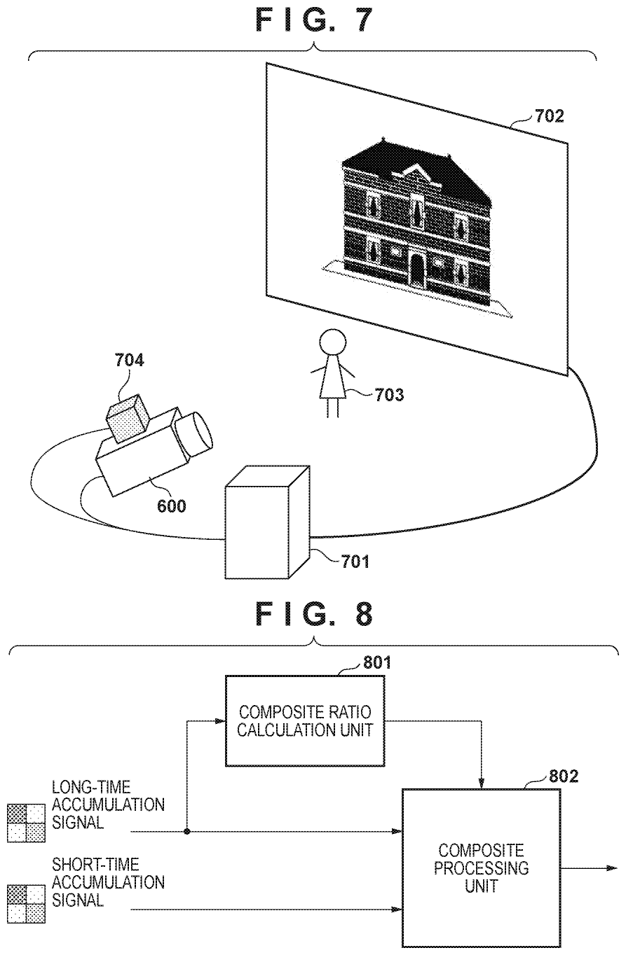

FIG. 8 is a view illustrating a simple block configuration of dynamic range expansion composite processing in the video signal processing unit 601 of the present embodiment.

In the present embodiment, a composite ratio calculation unit 801 calculates a composite ratio based on a long-time accumulation signal.

A composite processing unit 802 performs composite processing of a long-time accumulation signal and a short-time accumulation signal using the composite ratio calculated by the composite ratio calculation unit 801.

Specifically, let the long-time accumulation signal be L, the short-time accumulation signal be S, and the composite ratio be α, a composite signal H is described by the following Equation (1).

H=αS+(1−α)L (1)

Here, α takes a value in a range of 0 to 1, and the composite ratio calculation unit 801 calculates a value closer to 0 as the long-time accumulation signal L is smaller, and a value closer to 1 as the long-time accumulation signal L is larger.

Therefore, the ratio of the long-time accumulation signal L to the composite signal H increases as the long-time accumulation signal L decreases, and the ratio of the short-time accumulation signal S increases as the long-time accumulation signal L increases.

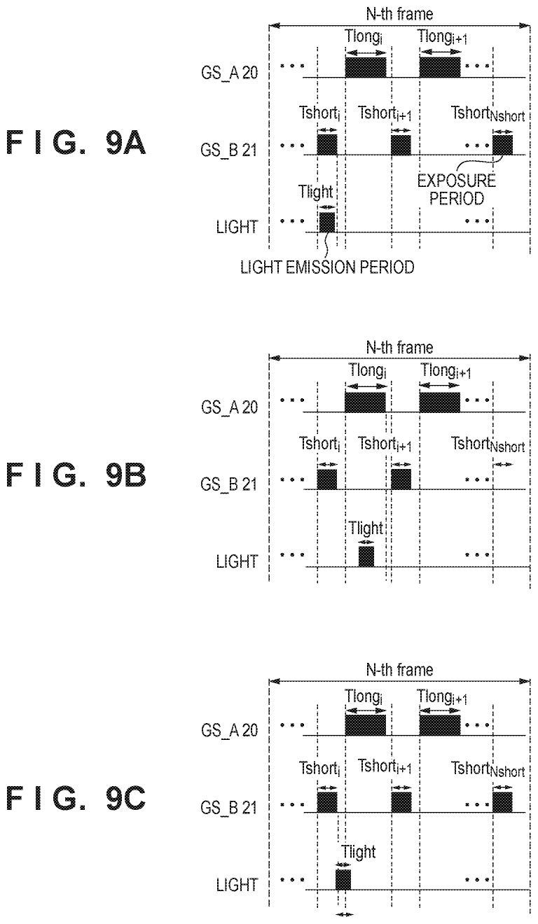

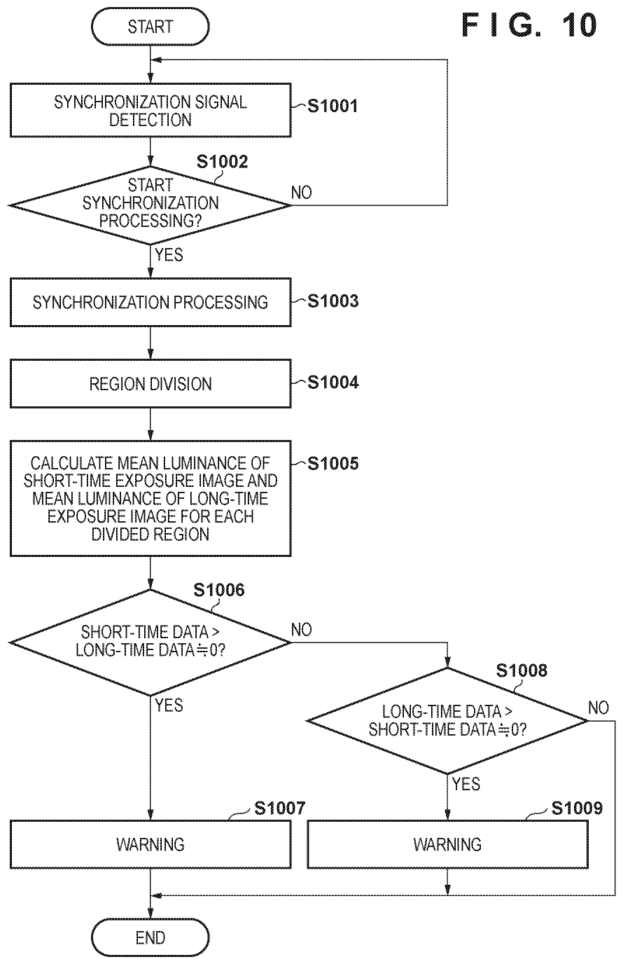

FIGS. 9A to 9C are views illustrating an exposure timing and a period of the image sensor 100 and a light emission timing and a period of the light source of the display apparatus 702. Configurations and processing similar to those in FIG. 3 are given identical reference signs, and detailed description will be omitted. Note that FIGS. 9A to 9C illustrate examples in which the ratio of Tshorti to Tlongi is 1:2.

FIG. 9A is a view illustrating a case in which a light emission period Tlight of the light source of display apparatus 702 falls within Tshorti. At this time, the long-time accumulation signal L has a value in the vicinity of 0, and therefore the composite ratio α calculated by the composite ratio calculation unit 801 has a value in the vicinity of 0. Therefore, as a result of the calculation shown in Equation (1), the composite signal H has a value in the vicinity of the long-time accumulation signal L, that is, a value in the vicinity of 0, and the video generated by the dynamic range expansion composite processing becomes a video with a luminance different from an assumed luminance.

FIG. 9B is a view illustrating a case in which Tlight falls within Tlongi. At this time, the short-time accumulation signal S has a value in the vicinity of 0. At this time, the composite signal H is described by Equation (2).

H≈(1−α)L (2)

At this time, in a case in which the long-time accumulation signal L is small, the composite signal H also becomes small. Even in a case in which the long-time accumulation signal L is large, the composite ratio α approaches 1, and therefore the composite signal H becomes small. Therefore, the video generated by the dynamic range expansion composite processing becomes a video with a luminance different from the assumed luminance.

FIG. 9C is a view illustrating a case in which Tlight straddles Tshorti and Tlongi. At this time, the composite signal H is calculated using both the long-time accumulation signal L and the short-time accumulation signal S, and therefore a video with a luminance close to the assumed luminance is generated as compared with the case of FIGS. 9A and 9B.

FIG. 10 is a flowchart describing warning notification processing of the present embodiment. The processing of this flowchart is implemented by the CPU 603 executing a program stored in the ROM 605.

In step S1001, the CPU 603 detects a synchronization signal input to the genlock terminal 616 using the synchronization signal detection unit 615. Then, a frame rate of the input synchronization signal is determined from the length between the timings of the horizontal synchronization signals and the length between the timings of the vertical synchronization signals.

In step S1002, the CPU 603 determines whether to start the synchronization processing from the period of the vertical synchronization signal generated by the synchronization signal generation unit 612 and the frame rate of the input synchronization signal detected by the synchronization signal detection unit 615. Specifically, for example, the synchronization processing is started in a case in which the frame rate of the input synchronization signal is 30 Hz and the free-running vertical synchronization signal has a frequency of an integral multiple such as 30 Hz or 60 Hz. In a case in which the synchronization processing is not started, for example, in a case in which the frame rate of the input synchronization signal is 30 Hz and the frequency of the free-running vertical synchronization signal is not an integral multiple such as 25 Hz or 50 Hz, the CPU 603 returns to step S1001.

In step S1003, the CPU 603 performs the synchronization processing described above, and keeps the phase difference between the free-running synchronization signal and the input synchronization signal within a predetermined range.

In step S1004, using the video signal processing unit 601, the CPU 603 divided the region of the video data generated based on the signal obtained from the image sensor 100.

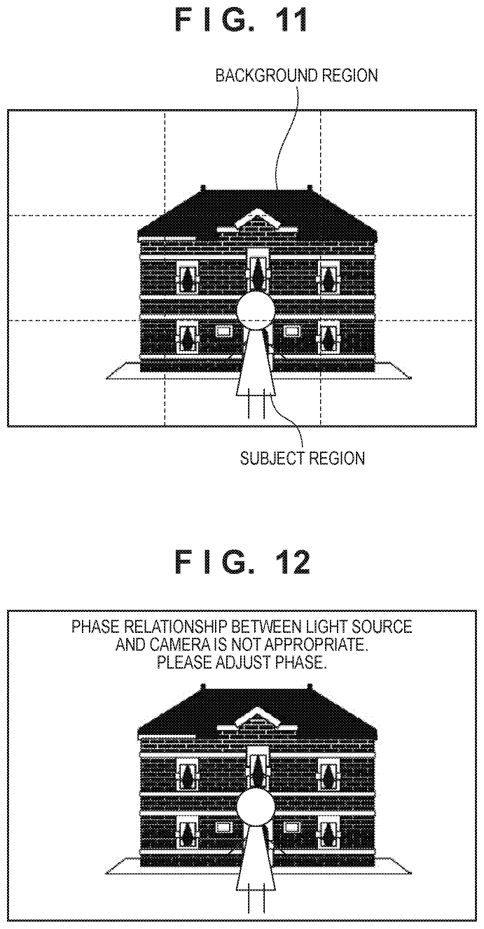

FIG. 11 is a view illustrating an example of region division of video data in step S1004. In FIG. 11, the region is divided into three vertically and three horizontally as indicated by the dotted lines, but the number of divisions may differ vertically and horizontally, and the number of divisions need not be limited to three vertically and horizontally.

In step S1005, using the video signal processing unit 601, the CPU 603 calculates the mean value of the long-time accumulation signals L and the mean value of the short-time accumulation signals S for each divided region.

In step S1006, the CPU 603 determines whether the mean value of the short-time accumulation signals S calculated in step S1005 is larger than the mean value of the long-time accumulation signals L and the mean value of the long-time accumulation signals L is close to 0 (whether it is a predetermined threshold value or less). This determination is made for each of the plurality of divided regions. In the case of the example of FIG. 11, since the number of divided regions is nine, it is performed nine times. In a case in which at least one of the plurality of divided regions satisfies this condition, the CPU 603 determines that there is a light source that intermittently emits light (determines whether or not there is a light source that intermittently emits light) and there is a region in which the light emission period Tlight falls within Tshorti, proceeds to step S1007, and otherwise, the CPU 603 proceeds to step S1008.

In step S1007, the CPU 603 determines that the phase relationship between the light emission timing of the light source of the display apparatus 702 and the exposure timing of the image sensor 100 is not appropriate. Then, the CPU 603 notifies the user of a warning that the light emission timing of the light source of the display apparatus 702 or the exposure timing of the image sensor 100 should be adjusted. Specifically, a character string indicating that is composited with the video data using the display processing unit 608 and output to the display unit 609.

FIG. 12 illustrates an example of a video displayed on the display unit 609. After the character string is displayed for a predetermined time, this flow ends.

Note that in step S1007, the CPU 603 may specifically notify the user that there is a region in which the light emission period Tlight falls within Tshorti.

In step S1008, the CPU 603 determines whether the mean value of the long-time accumulation signals L calculated in step S1005 is larger than the mean value of the short-time accumulation signals S and whether the mean value of the short-time accumulation signals S is close to 0 (whether it is a predetermined threshold value or less). This determination is also made for each of the plurality of divided regions. In the case of the example of FIG. 11, since the number of divided regions is nine, it is performed nine times. In a case in which at least one of the plurality of divided regions satisfies this condition, the CPU 603 determines that there is a light source that intermittently emits light and there is a region in which the light emission period Tlight falls within Tlongi, proceeds to step S1009, and otherwise ends this flow.

In step S1009, the CPU 603 determines that the phase relationship between the light emission timing of the light source of the display apparatus 702 and the exposure timing of the image sensor 100 is not appropriate. Then, the CPU 603 notifies the user that the light emission timing of the light source of the display apparatus 702 or the exposure timing of the image sensor 100 should be adjusted. Specifically, a character string indicating that is composited with the video data using the display processing unit 608 and output to the display unit 609. Then, after the character string is displayed for a predetermined time, this flow ends.

Note that in step S1009, the CPU 603 may specifically notify the user that there is a region in which the light emission period Tlight falls within Tlongi.

When the phase adjustment processing in response to the user operation described above is performed, by performing the processing in and after step S1004 in FIG. 10, it is also possible to notify the user whether the phase relationship between the light emission timing of the light source and the exposure timing of the image sensor 100 after the phase adjustment processing is appropriate.

Note that the present embodiment adopts a configuration in which the mean value of the short-time accumulation signals S and the mean value of the long-time accumulation signals L are compared, and in a case in which either of them is close to 0, the user is notified that the phase relationship is not appropriate. However, a configuration in which the phase relationship is determined not to be appropriate and the user is notified in a case in which the ratio of the mean value of the short-time accumulation signals S and the mean value of the long-time accumulation signals L is not in the vicinity of the ratio of Tshorti and Tlongi may be adopted. Specifically, for example, in a case in which the ratio of Tshorti and Tlongi is 1:2 as in the example illustrated in FIG. 9C, the user may be notified in a case in which the ratio of the mean value of the short-time accumulation signals S and the mean value of the long-time accumulation signals L is not in the vicinity of 1:2.

As described above, by performing the processing of the present embodiment, it is possible to prompt the user to perform phase adjustment in a case in which the phase relationship between the light emission timing of the light source and the exposure timing of the image sensor 100 is not appropriate. Then, it is possible to reduce the possibility that the light source is shot with a luminance different from an assumed luminance.

### Second Embodiment

An example of issuing a notification (issuing a warning) that prompts the user to perform phase adjustment in a case in which the phase relationship between the light emission timing of the light source and the exposure timing of the image sensor 100 is not appropriate is described in the first embodiment. In the second embodiment, an example of automatically adjusting the phase relationship between the light emission timing of the light source and the exposure timing of the image sensor 100 will be described.

Note that configurations and processing similar to those in the first embodiment are given identical reference signs, and detailed description will be omitted.

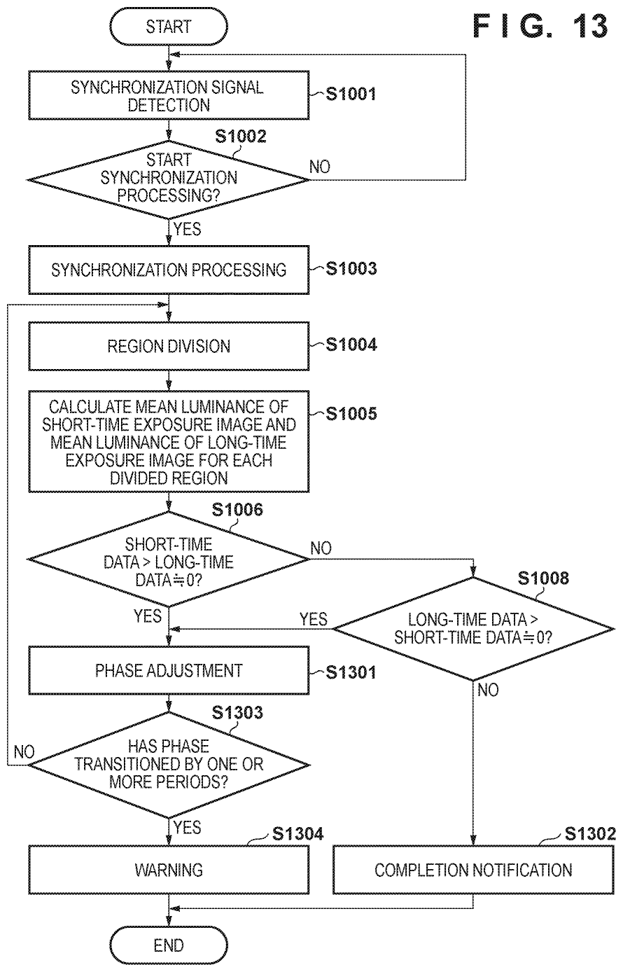

FIG. 13 is a flowchart showing automatic phase adjustment processing of the present embodiment.

The processing from step S1001 to step S1006 and step S1008 is similar to that of the first embodiment.

In a case of determining in step S1006 that there is a region in which the light emission period Tlight falls within Tshorti, the CPU 603 proceeds to step S1301, and otherwise, the CPU 603 proceeds to step S1008.

In a case of determining in step S1008 that there is a region in which the light emission period Tlight falls within Tlongi, the CPU 603 proceeds to step S1301, and otherwise, the CPU 603 proceeds to step S1302.

In step S1301, the CPU 603 re-generates and supplies, to each unit of the image capturing apparatus 600, the horizontal synchronization signal and the vertical synchronization signal shifted by a predetermined phase using the synchronization signal generation unit 612. In the present embodiment, a light source that periodically repeats light emission for a short time is mainly assumed to be an LED wall, and light sources of the entire screen are assumed to emit light in the same phase. Therefore, adjustment of the phases of the light emission timing and the exposure timing here may be performed not for each divided region but uniformly on the entire screen. Note that as a method of shifting the phase, the phase of the free-running synchronization signal with respect to the input synchronization signal may be shifted by temporarily changing the frequency of the clock output from the oscillation unit 613.

In step S1303, the CPU 603 determines whether the phase has transitioned by one or more periods, that is, whether the total phase change amount caused by shifting the phase in step S1301 has become the amount for one period of the vertical synchronization signal. If the phase has not transitioned by one or more periods, the CPU 603 returns to step S1004, and if the phase has transitioned by one or more periods, the CPU 603 proceeds to step S1304.

In step S1304, the CPU 603 displays, on the display unit 609, a warning such as a character string or an icon notifying the user that an appropriate phase relationship between the light emission timing of the light source and the exposure timing of the image sensor 100 has not been found. Specifically, using the display processing unit 608, a character string, an icon, or the like used for notification is composited with video data and output to the display unit 609. Thereafter, this flow ends.

In step S1302, the CPU 603 composites a character string, an icon, or the like notifying the user that the phase adjustment processing has ended with the video data using the display processing unit 608, and outputs it to the display unit 609. Thereafter, this flow ends.

Note that the present embodiment adopts a flow in which the determination of start of the synchronization processing is made based on the period of the vertical synchronization signal generated by the synchronization signal generation unit 612 and the period of the input synchronization signal. However, a screen for selecting whether or not to start the automatic phase adjustment processing may be output to the display unit 609, and the automatic phase adjustment processing may be started in response to the user's operation.

The present embodiment adopts a configuration in which the mean value of the short-time accumulation signals S and the mean value of the long-time accumulation signals L are compared, and in a case in which either of them is close to 0, the phase of the free-running synchronization signal is shifted. However, a configuration in which the phase relationship is determined not to be appropriate and the phase of the free-running synchronization signal is shifted in a case in which the ratio of the mean value of the short-time accumulation signals S and the mean value of the long-time accumulation signals L is not in the vicinity of the ratio of Tshorti and Tlongi may be adopted.

As described above, by performing the processing of the present embodiment, it is possible to automatically adjust the phase relationship between the light emission timing of the light source and the exposure timing of the image sensor 100, and reduce the possibility that the light source is shot with a luminance different from an assumed luminance.

### Third Embodiment

In the third embodiment, an example of changing dynamic range expansion composite processing of video data in response to the phase relationship between the light emission timing of the light source and the exposure timing of the image sensor 100 will be described.

Note that configurations and processing similar to those in the first embodiment are given identical reference signs, and detailed description will be omitted.

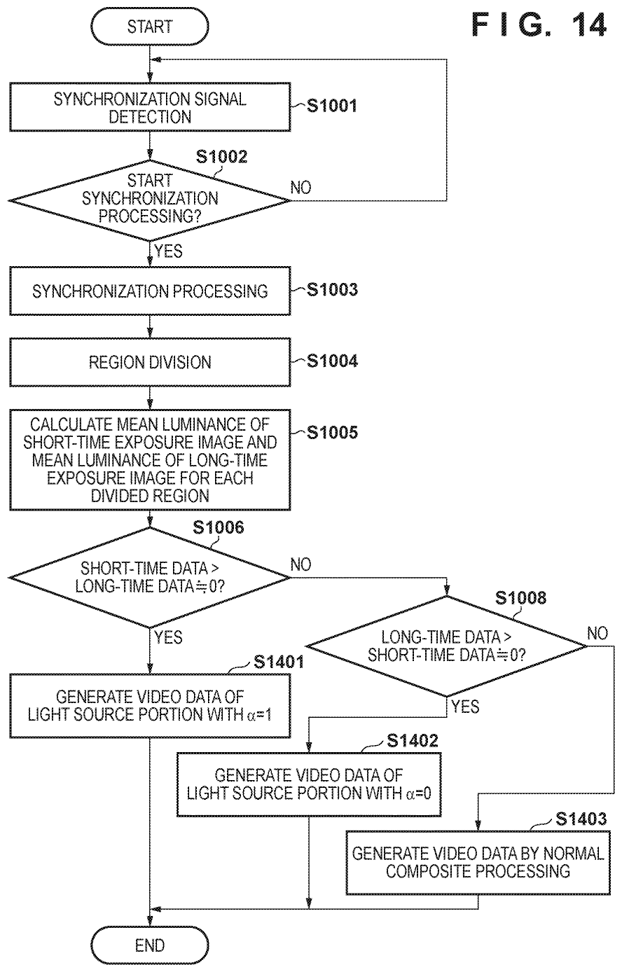

FIG. 14 is a flowchart describing the dynamic range expansion composite processing of video data of the present embodiment.

The processing from step S1001 to step S1006 and step S1008 is similar to that of the first embodiment.

In a case of determining in step S1006 that there is a region in which the light emission period Tlight falls within Tshorti, the CPU 603 proceeds to step S1401, and otherwise, the CPU 603 proceeds to step S1008.

In a case of determining in step S1008 that there is a region in which the light emission period Tlight falls within Tlongi, the CPU 603 proceeds to step S1402, and otherwise, the CPU 603 proceeds to step S1403.

In step S1401, the CPU 603 performs calculation with α being 1 in Equation (1) in the region determined in step S1006 that the light emission period Tlight falls within Tshorti. In a region other than the region in which it is determined that the light emission period Tlight falls within Tshorti, the composite ratio α is calculated based on the long-time accumulation signal L, and the calculation shown in Equation (1) is performed, thereby generating video data. Thereafter, this flow ends.

On the other hand, in step S1402, the CPU 603 performs calculation with α being 0 in Equation (1) in the region determined in step S1008 that the light emission period Tlight falls within Tlongi. In a region other than the region in which it is determined that the light emission period Tlight falls within Tlongi, the composite ratio α is calculated based on the long-time accumulation signal L, and the calculation shown in Equation (1) is performed, thereby generating video data. Thereafter, this flow ends.

In step S1403, the composite ratio α is calculated based on the long-time accumulation signal L, and the calculation shown in Equation (1) is performed, thereby generating video data. Thereafter, this flow ends.

Note that the present embodiment adopts a configuration in which the mean value of the short-time accumulation signals S and the mean value of the long-time accumulation signals L are compared, and in a case in which either of them is close to 0, the dynamic range expansion composite processing is performed with the composite ratio α being 1 or 0. However, a configuration in which the phase relationship is determined not to be appropriate and the dynamic range expansion composite processing is performed with the composite ratio α being 1 or 0 in a case in which the ratio of the mean value of the short-time accumulation signals S and the mean value of the long-time accumulation signals L is not in the vicinity of the ratio of Tshorti and Tlongi may be adopted.

As described above, in the present embodiment, the dynamic range expansion composite processing of video data is changed in a case in which the phase relationship between the light emission timing of the light source and the exposure timing of the image sensor 100 is not appropriate. This can reduce the possibility that the light source is shot with a luminance different from an assumed luminance.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-080611, filed May 13, 2025, which is hereby incorporated by reference herein in its entirety.

What is claimed is:

1. An image capturing apparatus comprising:
an image sensor including a plurality of pixels arrayed in a matrix; and
at least one processor or circuit and a memory storing instructions to cause the at least one processor or circuit to perform operations of the following units
an image capturing control unit that controls image capturing in the image sensor,
a composite processing unit that performs composite processing for compositing a first image signal obtained in first image capturing and a second image signal obtained in second image capturing, the first image signal and the second image signal being obtained by the image capturing control unit causing each pixel of the image sensor to perform the first image capturing with a first exposure time and the second image capturing with a second exposure time different from the first exposure time, and
a determination unit that, based on the first image signal and the second image signal, determines presence/absence of a light source that intermittently emits light, and determine whether a phase relationship between timings of the first image capturing and the second image capturing and a timing of light emission of the light source that intermittently emits light is a predetermined phase relationship.

2. The image capturing apparatus according to claim 1 further comprising a device that issues a warning in a case in which the phase relationship is not the predetermined phase relationship.

3. The image capturing apparatus according to claim 1, wherein the determination unit determines whether the phase relationship is the predetermined phase relationship based on images of a plurality of divided regions in which each of a first image based on the first image signal and a second image based on the second image signal is divided.

4. The image capturing apparatus according to claim 3, wherein the determination unit determines whether the phase relationship is the predetermined phase relationship by comparing a mean value of luminance of the divided regions of the first image with a mean value of luminance of the divided regions of the second image.

5. The image capturing apparatus according to claim 4, wherein the determination unit determines that the phase relationship is not the predetermined phase relationship in a case in which a smaller value of the mean value of luminance of the divided regions of the first image and the mean value of luminance of the divided regions of the second image is a predetermined threshold value or less.

6. The image capturing apparatus according to claim 4, wherein the determination unit determines that the phase relationship is not the predetermined phase relationship in a case in which a ratio of the mean value of luminance of the divided regions of the first image and the mean value of luminance of the divided regions of the second image is not in a vicinity of a ratio of the first exposure time and the second exposure time.

7. The image capturing apparatus according to claim 1, wherein the at least one processor or circuit is configured further performing as
an input unit that inputs an external synchronization signal, a generation unit that generates an internal synchronization signal serving as a reference of start timings of the first exposure time and the second exposure time, a synchronization processing unit that synchronizes the internal synchronization signal with the external synchronization signal, and an adjustment unit that adjusts a phase of the internal synchronization signal, and
wherein the adjustment unit adjusts the phase of the internal synchronization signal so that the phase relationship becomes the predetermined phase relationship.

8. The image capturing apparatus according to claim 1, wherein the composite processing unit changes the composite processing depending on whether or not the phase relationship is the predetermined phase relationship.

9. The image capturing apparatus according to claim 1, wherein the pixel of the image sensor includes a photoelectric conversion portion and a plurality of charge holding portions provided for the photoelectric conversion portion, and the plurality of charge holding portions hold pixel signals of different exposure times of the photoelectric conversion portion.

10. The image capturing apparatus according to claim 9, wherein pixel signals for all pixels are simultaneously transferred from the photoelectric conversion portion to the charge holding portion.

11. The image capturing apparatus according to claim 1, wherein the first image capturing with the first exposure time and the second image capturing with the second exposure time are performed a plurality of times.

12. A control method of an image capturing apparatus including an image sensor including a plurality of pixels arrayed in a matrix, the control method comprising:
controlling image capturing in the image sensor;
performing composite processing for compositing a first image signal obtained in first image capturing and a second image signal obtained in second image capturing, the first image signal and the second image signal being obtained by the image capturing control causing each pixel of the image sensor to perform the first image capturing with a first exposure time and the second image capturing with a second exposure time different from the first exposure time; and
based on the first image signal and the second image signal, determining presence/absence of a light source that intermittently emits light, and determining whether a phase relationship between timings of the first image capturing and the second image capturing and a timing of light emission of the light source that intermittently emits light is a predetermined phase relationship.

13. A non-transitory computer-readable storage medium storing a program for causing a computer to execute each process of a control method of an image capturing apparatus including an image sensor including a plurality of pixels arrayed in a matrix, the control method comprising:
controlling image capturing in the image sensor;
performing composite processing for compositing a first image signal obtained in first image capturing and a second image signal obtained in second image capturing, the first image signal and the second image signal being obtained by the image capturing control causing each pixel of the image sensor to perform the first image capturing with a first exposure time and the second image capturing with a second exposure time different from the first exposure time; and
based on the first image signal and the second image signal, determining presence/absence of a light source that intermittently emits light, and determining whether a phase relationship between timings of the first image capturing and the second image capturing and a timing of light emission of the light source that intermittently emits light is a predetermined phase relationship.
